(19) United States
(12) Patent Application Publication
(10) Pub. No.: US 2005/0281946 A1
(43) Pub. Date: Dec. 22, 2005

(54) Method for producing a stratified composite material

(76) Inventors: Robert Mergen, Altmunster (AT); Gunter Kutzik, Gmunden (AT)

Correspondence Address: WILLIAM COLLARD;COLLARD & ROE, P.C., 1077 NORTHERN BOULEVARD, ROSLYN, NY, 11576, US

(21) Appl. No.: 11/142,146

(22) Filed: Jun. 1, 2005

(30) Foreign Application Priority Data
Jun. 2, 2004 (AT) A 946/2004

(51) Int. Cl. B05D 1/12

(52) U.S. Cl. 427/180

(57) ABSTRACT

A method is described for producing a stratified composite material, with a layer of sinterable solids particles being applied to a strip-like metal carrier and being sintered with liquid phase by the supply of heat continuously in the forward feed direction. In order to provide simplified production conditions it is proposed that the metal carrier is heated continuously in the forward feed direction with a temperature profile which decreases towards lower temperatures from a maximum temperature above the melting temperature of the solids particles in the region of a surface layer receiving the particle layer towards a core layer of the metal carrier, and that the particle layer is sintered at least in a layer resting on the metal carrier by a heat transmission from the heated metal carrier.

### FIELD OF THE INVENTION

The invention relates to a method for producing a stratified composite material, with a layer of sinterable solids particles being applied to a strip-like metal carrier and being sintered with liquid phase by the supply of heat continuously in the forward feed direction.

### DESCRIPTION OF THE PRIOR ART

In order to enable the production of a stratified composite material which consists for example of a steel carrier and a layer material on the basis of copper and which is used for slide bearings by sintering the layer material which is applied to the steel carrier in powder form without having to guide the strip-like steel carrier with the applied sintering powder through a complex sintering furnace and a downstream cooling apparatus, it is known (GB 2 383 051 A) to melt with the help of laser beams the sintering powder of the layer material sprinkled onto the steel carrier over the width of the strip-like steel carrier in a locally limited longitudinal region and, following this melting region, to rapidly cool the same from the side of the steel carrier in order to achieve an outwardly progressing solidification of the layer material starting from the surface of the steel carrier with a fine-grained, dendritic structure. Although this method for producing a stratified composite material can be used to considerably reduce the length of a required installation in comparison with conventional systems for sintering stratified composite materials, the high complexity of the system remains due to the required use of laser devices over the width of the strip-like steel carrier.

### SUMMARY OF THE INVENTION

The invention is thus based on the object of providing a method for producing a stratified composite material of the kind mentioned above in such a way that the advantages of sintering with liquid phase which progresses in the forward feed direction and is limited to a short longitudinal region can be utilized without having to heat the respective layer of the layer material to sintering temperature with the help of laser devices.

This object is achieved by the invention in such a way that the metal carrier is heated continuously in the forward feed direction with a temperature profile which decreases from a maximum temperature above the melting temperature of the solids particles in the region of a surface layer receiving the particle layer towards a core layer of the metal carrier to lower temperatures, and that the particle layer is sintered at least in a layer resting on the metal carrier by a heat transmission from the heated metal carrier.

Since as a result of these measures the heated metal carrier has a temperature drop starting from a maximum temperature in the region of the surface layer receiving the particle layer in the direction towards a core layer, it is possible, despite the heating of the solids particles of the layer material to the sintering temperature required for a sintering with liquid phase by a heat transmission from the metal carrier, to ensure an outwardly progressing solidification of the liquid phase starting from the surface of the metal carrier. The melting heat withdrawn from the metal carrier from its layer close to the surface leads to a cooling of the layers of the metal carrier close to the surface in the case of a respective adjustment of the relevant conditions as a result of the temperature drop and thus to a solidification of the liquid phase with growing advancement progressing from the inside to the outside. The relevant aspect is a sufficient temperature drop which should be at least 5 K/mm in order to ensure the desired effect in numerous applications.

Due to the penetration depth of an electromagnetic alternating field into a strip-like metal carrier which depends relevantly on the frequency, the desired temperature profile for the heating of the metal carrier can be achieved advantageously by an inductive heating, since different field densities can easily be set by a respective arrangement of the windings of the exciting winding in the region of the mutually opposite surfaces of the strip-like metal carrier or by a winding arrangement on one side. In this way it is possible to continuously heat the metal carrier in the forward feed direction with the respectively desired temperature profile in order to transmit the melting heat from the metal carrier onto the applied particle layer which is required for the sintering of the solids particles with liquid phase. The particle layer can be produced with conventional sintering powders. It is also possible to use considerably coarse-grained materials or granulates without endangering the desired sintering by heat transmission from the metal carrier.

The thermal energy required for the sintering of the solids particles over the entire layer thickness does not have to be produced completely through the heating of the metal carrier. The particle layer applied onto the metal carrier can be additionally heated in an inductive way during the sintering process, so that merely a layer of the solids particles resting on the metal carrier is sintered by a heat transmission from the heated metal carrier with liquid phase. With the melting of a partial layer of the solids particles, eddy currents can be induced in this molten partial layer which ensure a respective additional heat in order to accelerate the sintering process to the outside. The solidification of the sintering material initiated through the cooled metal carrier is not affected thereby, so that even thicker layer materials can be sintered with a comparatively low amount of work. This is of subordinate importance with respect to the stratified composite materials for slide bearings however. Moreover, the solids particles can be preheated prior to sintering in order to make do with a lower thermal energy in the region of the metal carrier.

### BRIEF DESCRIPTION OF THE DRAWINGS

The method in accordance with the invention will be explained below in closer detail by reference to the drawings, wherein:

FIG. 1 shows an apparatus for producing a stratified composite material according to the method in accordance with the invention in a schematic longitudinal sectional view;

FIG. 2 shows a representation according to FIG. 1 of a constructional variant of an apparatus for producing a stratified composite material;

FIG. 3 shows the temperature progress over time during the inductive heating of the metal carrier in a surface layer and in a core layer, and

FIG. 4 shows the temperature drop between a surface layer and a core layer of the metal carrier during a heating curve according to FIG. 3.

### DESCRIPTION OF THE PREFERRED EMBODIMENTS

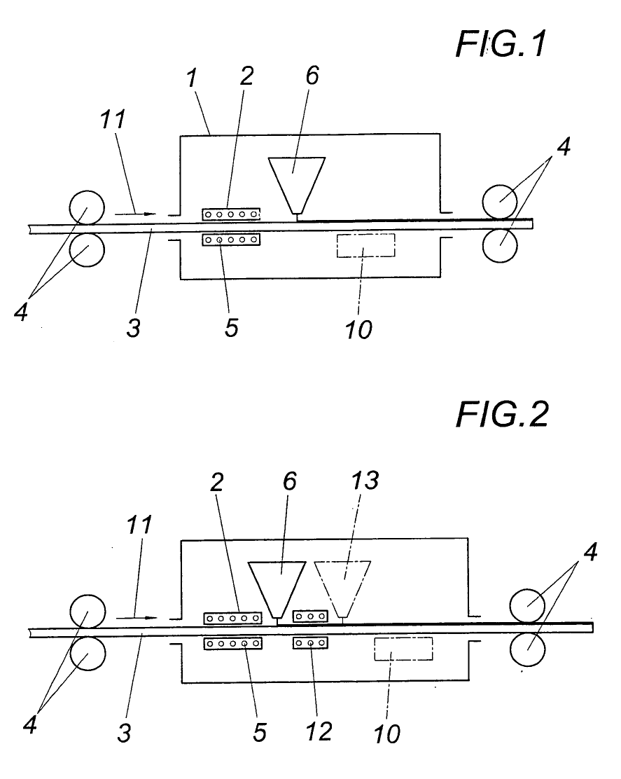

According to the embodiment according to FIG. 1, a device 2 for the inductive heating of a strip-like metal carrier 3 is provided within a protective hood 1 for maintaining an atmosphere of inert gas, which carrier is conveyed with the help of driving rollers 4 through the protective hood 1 and is heated on passing through the windings 5 of at least one inductive coil before solids particles (e.g. a sintering powder) is applied onto the metal carrier 3 for the applied layer material with the help of a scattering device 6.

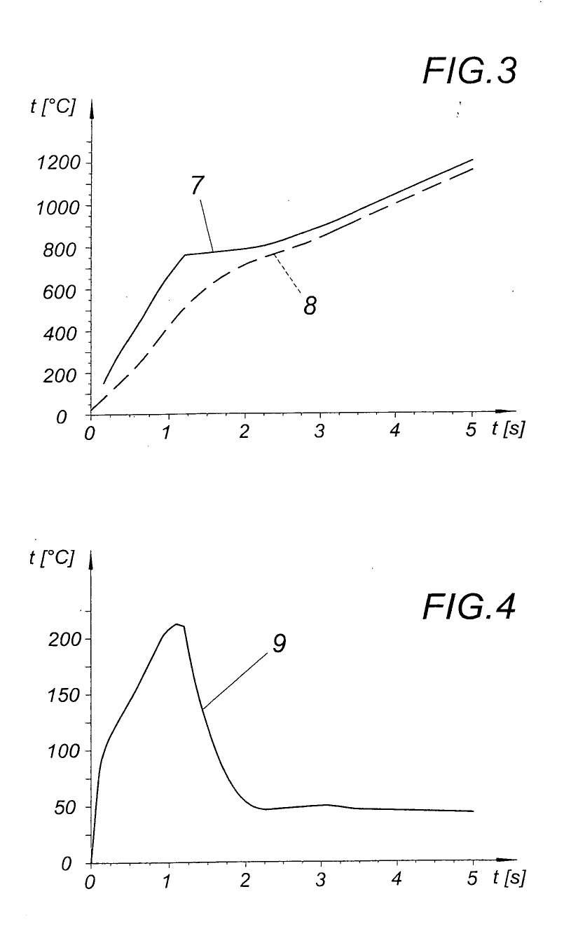

FIG. 3 shows the heating curve over time for a steel metal carrier 3 with a thickness of 5 mm shown on the one hand in a surface layer and on the other hand in a core layer. The curve 7 of the surface temperature as shown with the unbroken line leads to the consequence that at a suitable field frequency of 200 kHz for example the surface temperature of the metal carrier 3 rises only gradually again after exceeding the Curie point. However, in the case of a respective energy supply the necessary maximum temperature of 1100° C. to 1200° C. which lies above the melting temperature of the solids particles can easily be reached within a time frame of 4 to 5 seconds. As a result of the penetration depth of the magnetic alternating field which depends on the excitation frequency, the core temperature follows the surface temperature 7 of the metal carrier 3 according to the curve 8 as shown with the broken line with a time delay, so that within the metal carrier 3 a temperature profile is obtained with a temperature drop from a respective maximum temperature in a surface layer to respectively lower temperatures in a core layer. The temperature difference between the temperature curve 7 in the surface region and the temperature curve 8 in the core region is shown in FIG. 4 on a larger scale as curve 9. It can be seen that although after exceeding the Curie point the temperature difference between the surface and the core decreases, this temperature difference however does not fall below 50° C. under the predetermined conditions in the region of the desired end temperature. This means that after heating the metal carrier 3 to a surface temperature exceeding the melt temperature of the solids particles, a sufficient temperature gradient is obtained in the direction of the core layer of the metal carrier 3, so that despite the transmission of the melting heat from the metal carrier to the particle layer and the thus linked sintering of the layer material with liquid phase the solidification of the molten solids particles starts from the surface of the metal carrier 3 and progresses to the outside. The cooling of the molten solids particles initiated through the occurring temperature gradients can be supported by a cooling of the metal carrier 1 from the side averted from the layer material, as is explained by a cooling device 10 as indicated with the dot-dash line in FIG. 1.

Since the metal carrier 3 is progressively inductively heated in a forward feed direction 11, with the heating zone being limited to a short length region determined by the inductive heating device 2 and with the scattered particle layer also being sintered in a limited length section of the heated metal carrier 3 with liquid phase in order to thereafter be cooled directly from the metal carrier 3, a comparatively short overall length is obtained for the sintering apparatus, which thus ensures that metal carriers 3 present both as strips and plates can be provided with a layer material for producing stratified composite materials.

The embodiment in accordance with FIG. 2 corresponds substantially to that of FIG. 1. In contrast to the embodiment according to FIG. 1, the device 2 is associated with an additional coil with windings 12 which are provided downstream to the scattering device 6 in the forward feed direction 11 and is configured in such a way that it is not necessary to transmit the entire melting energy for the particle layer via the metal carrier 3 onto the particle layer. It is understood that such additional induction windings 12 also allow a subsequent scattering of solids particles, as is indicated by the scattering device 13 shown by the dot-dash line.

It is understood that the invention is not limited to the illustrated embodiments because an influence can be taken on the sintering process and the formation of the layer material both with respect to the coil arrangement and the scattering of the solids particles. Since no limitations are enforced both with respect to the pretreatment of the metal carrier 3 to be sintered as well as with respect to the after-treatment of the stratified composite material by the method in accordance with the invention, there will not be any further discussion of the conventional pre-treatments and after-treatments.

1. A method for producing a stratified composite material, with a layer of sinterable solids particles being applied to a strip-like metal carrier and being sintered with liquid phase by the supply of heat continuously in the forward feed direction, wherein the metal carrier is heated continuously in the forward feed direction with a temperature profile which decreases towards lower temperatures from a maximum temperature above the melting temperature of the solids particles in the region of a surface layer receiving the particle layer towards a core layer of the metal carrier, and that the particle layer is sintered at least in a layer resting on the metal carrier by a heat transmission from the heated metal carrier.

2. A method according to claim 1, wherein the metal carrier is heated to a temperature profile with a temperature drop of at least 5K/mm.

3. A method according to claim 1, wherein the strip-like metal carrier is heated inductively.

4. A method according to claim 1, wherein the particle layer is additionally heated inductively during the sintering process.

5. A method according to claim 1, wherein the solids particles are preheated prior to the sintering process.
